(19) United States
(12) Patent Application Publication
(10) Pub. No.: US 2026/0287362 A1
(43) Pub. Date: Sep. 24, 2026

(54) Inertial Measurement Unit

(71) Applicant: SEIKO EPSON CORPORATION, Tokyo (JP)

(72) Inventor: Yasushi NAKAOKA, Shiojiri (JP)

(21) Appl. No.: 19/569,349

(22) Filed: Mar. 17, 2026

(30) Foreign Application Priority Data
Mar. 18, 2025 (JP) 2025-043885

(51) Int. Cl. G01C 21/16; G01P 7/00; G01P 15/18

(52) U.S. Cl. CPC G01C 21/188; G01P 7/00; G01P 15/18

(57) ABSTRACT

An inertial measurement unit includes a three-axis angular velocity sensor that measures a three-axis angular velocity for each first period, a minute posture change calculation portion that calculates a posture change quaternion representing a posture change in the first period based on the three-axis angular velocity measured by the three-axis angular velocity sensor, a posture increment calculation portion that calculates a posture quaternion by combining the posture change quaternions for each first period, and calculates a posture increment quaternion representing a posture increment in a second period, an angle increment calculation portion that calculates an angle increment in the second period based on the posture increment quaternion, and an interface portion that transmits the angle increment to an external device for each second period.

The present application is based on, and claims priority from JP Application Serial Number 2025-043885, filed Mar. 18, 2025, the disclosure of which is hereby incorporated by reference herein in its entirety.

### BACKGROUND

### 1. Technical Field

The present disclosure relates to an inertial measurement unit.

### 2. Related Art

JP-A-9-5104 discloses a technology for correcting, via a computing device, a measurement value of a three-dimensional posture angle of a moving object by integrating measurement values of angular velocities obtained by three angular velocity sensors with respect to time to calculate the measurement value of the three-dimensional posture angle of the moving object, and applying an extended Kalman filter that takes a gravitational acceleration vector obtained from three acceleration sensors as an observation vector.

In JP-A-9-5104, the computing device integrates the measurement values of the angular velocities with respect to time. Accordingly, in order to correct a drift that occurs in the measurement value of the three-dimensional posture angle and increases as time passes, the extended Kalman filter that takes the gravitational acceleration vector as an observation vector needs to be applied, and a calculation load of an external device of the angular velocity sensor significantly increases.

### SUMMARY

According to an aspect of the present disclosure, there is provided an inertial measurement unit including a three-axis angular velocity sensor that measures a three-axis angular velocity along three axes orthogonal to each other for each first period, a minute posture change calculation portion that calculates a posture change quaternion representing a posture change in the first period based on the three-axis angular velocity measured by the three-axis angular velocity sensor, a posture increment calculation portion that calculates a posture quaternion by combining the posture change quaternions for each first period, and calculates a posture increment quaternion representing a posture increment in a second period longer than the first period, an angle increment calculation portion that calculates an angle increment in the second period based on the posture increment quaternion, and an interface portion that transmits the angle increment to an external device for each second period.

### BRIEF DESCRIPTION OF THE DRAWINGS

FIG. 1 is an exploded perspective view of an inertial measurement unit.

FIG. 2 is a top view of a circuit substrate included in the inertial measurement unit.

FIG. 3 is a bottom view of the circuit substrate shown in FIG. 2.

FIG. 4 is a diagram showing an example of a functional configuration of the inertial measurement unit of a first embodiment.

FIG. 5 is a flowchart showing an example of a procedure for calculating an angle increment and a velocity increment in the first embodiment.

FIG. 6 is a graph showing a simulation result of a drift in a yaw angle.

FIG. 7 is a graph showing a simulation result of a drift in a velocity in a Y-axis direction.

FIG. 8 is a diagram showing an example of a functional configuration of an inertial measurement unit of a second embodiment.

FIG. 9 is a flowchart showing an example of a procedure for calculating an angle increment in the second embodiment.

### DESCRIPTION OF EMBODIMENTS

Hereinafter, exemplary embodiments of the present disclosure will be described in detail with reference to the drawings. The embodiments described below do not unduly limit the contents of the present disclosure according to the claims. In addition, not all configurations described below are necessarily essential requirements of the present disclosure.

### 1. First Embodiment

### 1-1. Structure of Inertial Measurement Unit

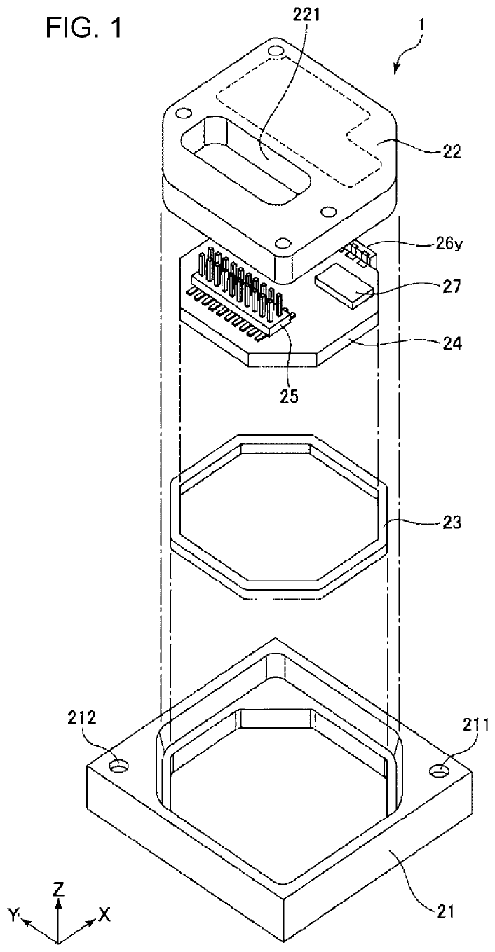

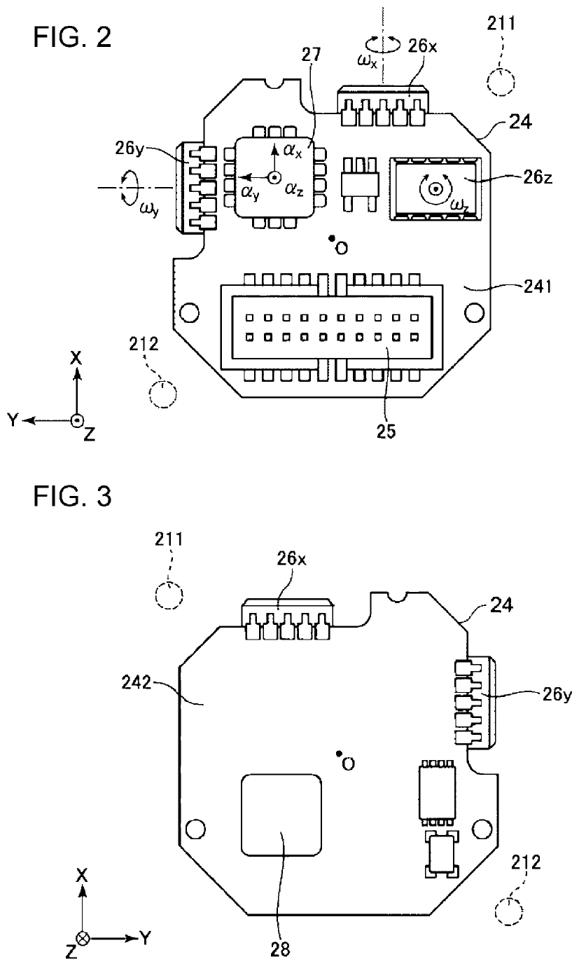

An inertial measurement unit 1 of the present embodiment detects, for example, a motion of a moving object such as a vehicle, a robot, or a drone, or other various objects on which the inertial measurement unit 1 is mounted. FIGS. 1 to 3 are diagrams showing an example of a structure of the inertial measurement unit 1. FIG. 1 is an exploded perspective view of the inertial measurement unit 1. FIG. 2 is a top view of a circuit substrate 24 included in the inertial measurement unit 1. FIG. 3 is a bottom view of the circuit substrate 24 shown in FIG. 2.

As shown in FIG. 1, the inertial measurement unit 1 includes an outer case 21, an inner case 22, a joining member 23, and the circuit substrate 24. The outer case 21 has a recess portion into which the inner case 22 is inserted. The outer case 21 and the inner case 22 are joined to each other by the joining member 23 in a state where the outer case 21 and the inner case 22 accommodate and hold the circuit substrate 24. That is, since the inner case 22 is accommodated in the outer case 21 having a rectangular parallelepiped shape, a planar shape of the inertial measurement unit 1 is a rectangular parallelepiped having a substantially square shape, and the inertial measurement unit 1 is configured to be compact such that a length of one side of the square is approximately a few centimeters.

An opening 221 having a rectangular shape is formed in the inner case 22. Hereinafter, a longitudinal direction of the opening 221 will be referred to as a Y direction. In addition, in the following description, a direction orthogonal to the Y direction will be referred to as an X direction, a thickness direction of the outer case 21 will be referred to as a Z direction, and the X, Y, and Z directions will be shown as coordinate axes. A plug-type connector 25 is exposed through the opening 221 of the inner case 22. The Y direction coincides with an arrangement direction of a plurality of pins in the connector 25. In addition, the coordinate axes are detection axes of the inertial measurement unit 1. In the present embodiment, the inertial measurement unit 1 detects a three-axis acceleration α=(αₓ, α_{y}, α_{z}) that is applied in each direction of an X axis, a Y axis, and a Z axis orthogonal to each other, and a three-axis angular velocity ω=(ωₓ, ω_{y}, ω_{z}) having rotation axes on each of the X axis, the Y axis, and the Z axis.

The inertial measurement unit 1 seen from an upper position, that is, in the Z-axis direction, has a square shape. The outer case 21 has, for example, screw holes 211 and 212 provided in a pair of corner portions, respectively, positioned at diagonal corners of an upper surface of the outer case 21. The inertial measurement unit 1 is fixed to an external substrate, not shown, by screwing the inertial measurement unit 1 using the screw holes 211 and 212.

As shown in FIGS. 2 and 3, a module connector 25, angular velocity sensors 26x, 26y, and 26z, a three-axis acceleration sensor 27, a processing circuit 28, and the like are mounted on the circuit substrate 24.

The circuit substrate 24 seen in the Z-axis direction has, for example, a square shape. The module connector 25, the angular velocity sensor 26z, and the three-axis acceleration sensor 27 are disposed on an upper surface 241 of the circuit substrate 24. The angular velocity sensors 26x and 26y are disposed on two side surfaces of the circuit substrate 24, respectively, that are orthogonal to each other. The processing circuit 28 is disposed on a lower surface 242 of the circuit substrate 24.

The module connector 25 couples the inertial measurement unit 1 and an external substrate, not shown. The module connector 25 is exposed to the external substrate through, for example, the opening 221 provided in the inner case 22. The angular velocity sensor 26x detects the angular velocity ωₓ about the X axis. The angular velocity sensor 26y detects the angular velocity ω_{y} about the Y axis. The angular velocity sensor 26z detects the angular velocity ω_{z} about the Z axis. Each of the angular velocity sensors 26x and 26y is, for example, a crystal gyro sensor that includes a sensor element made of crystal and detects an angular velocity with high accuracy. However, each of the angular velocity sensors 26x and 26y may not be a crystal gyro sensor and may be, for example, a MEMS angular velocity sensor including a sensor element of which a silicon substrate is processed using MEMS technology. MEMS is the abbreviation for Micro Electro Mechanical Systems.

The three-axis acceleration sensor 27 detects the acceleration αₓ in the X-axis direction, the acceleration α_{y} in the Y-axis direction, and the acceleration α_{z} in the Z-axis direction. The three-axis acceleration sensor 27 is, for example, a MEMS acceleration sensor of a capacitive type including a sensor element of which a silicon substrate is processed using MEMS technology. However, the three-axis acceleration sensor 27 may not be a MEMS acceleration sensor and may be, for example, a crystal acceleration sensor that includes a sensor element made of crystal and detects an acceleration with high accuracy.

The processing circuit 28 is configured with, for example, an integrated circuit. The processing circuit 28 is coupled to the three-axis acceleration sensor 27 and each of the angular velocity sensors 26x, 26y, and 26z through the circuit substrate 24. The processing circuit 28 calculates an angle increment Δθ and a velocity increment Δv for each output period Δt based on the three-axis acceleration α=(αₓ, α_{y}, α_{z}) detected by the three-axis acceleration sensor 27 and on the three-axis angular velocity ω=(ωₓ, ω_{y}, ω_{z}) detected by the angular velocity sensors 26x, 26y, and 26z, and transmits the angle increment Δθ and the velocity increment Δv to a host device, not shown. Details of processing of calculating the angle increment Δθ and the velocity increment Δv by the processing circuit 28 will be described later.

### 1-2. Functional Configuration of Inertial Measurement Unit

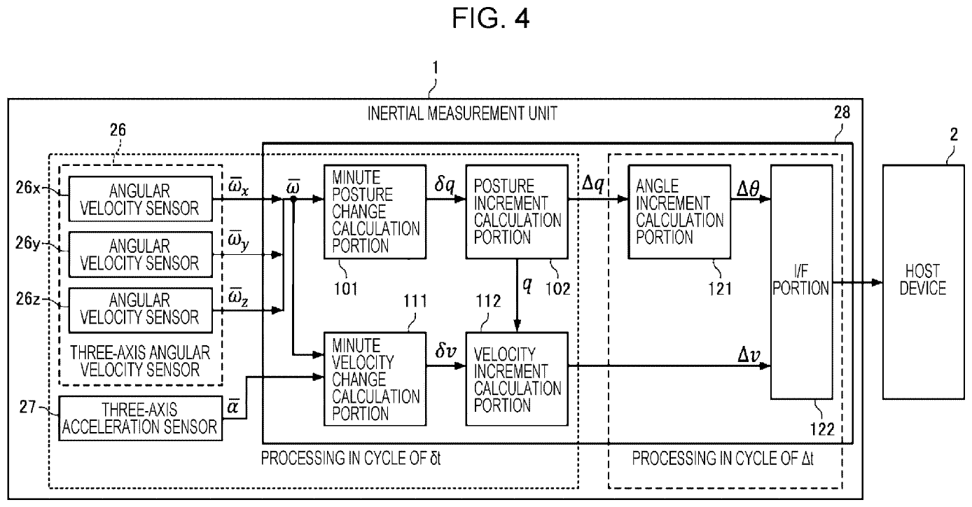

FIG. 4 is a diagram showing an example of a functional configuration of the inertial measurement unit 1 of the first embodiment. As shown in FIG. 4, the inertial measurement unit 1 includes the three-axis acceleration sensor 27, the angular velocity sensors 26x, 26y, and 26z, and the processing circuit 28, and is coupled to a host device 2.

The angular velocity sensor 26x measures the angular velocity ωₓ about the X axis. The angular velocity sensor 26y measures the angular velocity ω_{y} about the Y axis. The angular velocity sensor 26z measures the angular velocity oz about the Z axis. The three-axis acceleration sensor 27 measures the three-axis acceleration α consisting of the acceleration αₓ in the X-axis direction, the acceleration α_{y} in the Y-axis direction, and the acceleration α_{z} in the Z-axis direction. The angular velocity sensors 26x, 26y, and 26z measure the angular velocities ωₓ, ω_{y}, and ω_{z}, respectively, for each sampling period δt. That is, the angular velocity sensors 26x, 26y, and 26z constitute a three-axis angular velocity sensor 26 that measures the three-axis angular velocity ω=(ωₓ, ω_{y}, ω_{z}) along three axes for each sampling period δt. In addition, the three-axis acceleration sensor 27 measures the three-axis acceleration α=(αₓ, α_{y}, α_{z}) along three axes of the X axis, the Y axis, and the Z axis for each sampling period δt. The sampling period δt is, for example, several hundred microseconds to several milliseconds.

The three-axis angular velocity ω=(ωₓ, ω_{y}, ω_{z}) consisting of the angular velocities ωₓ, ω_{y}, and ω_{z} measured by the angular velocity sensors 26x, 26y, and 26z, respectively, and the three-axis acceleration α=(αₓ, α_{y}, α_{z}) measured by the three-axis acceleration sensor 27 are input into the processing circuit 28.

The processing circuit 28 calculates the angle increment Δθ and the velocity increment Δv for each output period Δt based on the three-axis acceleration α=(αₓ, α_{y}, α_{z}) and on the three-axis angular velocity ω=(ωₓ, ω_{y}, ω_{z}), and transmits the angle increment Δθ and the velocity increment Δv to the host device 2. The output period Δt is longer than the sampling period δt and is, for example, several milliseconds to several hundred milliseconds.

The host device 2 receives the angle increment Δθ and the velocity increment Δv for each output period Δt and, for example, calculates a posture and a position of the inertial measurement unit 1 by integrating the angle increment Δθ and the velocity increment Δv with respect to time.

The processing circuit 28 actually performs various types of correction processing such as misalignment correction and correction of an offset error and a scale factor error in addition to the processing of calculating the angle increment Δθ and the velocity increment Δv. However, FIG. 4 shows only a circuit block for calculating the angle increment Δθ and the velocity increment Δv and does not show a circuit block for performing the various types of correction processing.

As shown in FIG. 4, the processing circuit 28 includes a minute posture change calculation portion 101, a posture increment calculation portion 102, a minute velocity change calculation portion 111, a velocity increment calculation portion 112, an angle increment calculation portion 121, and an interface portion 122.

The minute posture change calculation portion 101 calculates a posture change quaternion δq representing a posture change of the inertial measurement unit 1 in the period δt, based on the three-axis angular velocity ω measured by the three-axis angular velocity sensor 26.

The posture increment calculation portion 102 calculates a posture quaternion q by combining the posture change quaternions δq calculated by the minute posture change calculation portion 101 for each period δt, and calculates a posture increment quaternion Δq representing a posture increment of the inertial measurement unit 1 in the period Δt longer than the period δt.

The minute velocity change calculation portion 111 calculates a velocity change δv of the inertial measurement unit 1 in the period δt based on the three-axis angular velocity ω measured by the three-axis angular velocity sensor 26 and on the three-axis acceleration α measured by the three-axis acceleration sensor 27.

The velocity increment calculation portion 112 calculates the velocity increment Δv of the inertial measurement unit 1 in the period Δt by accumulating the velocity change δv calculated by the minute velocity change calculation portion 111 for each period δt with reference to the posture quaternion q calculated by the posture increment calculation portion 102.

The angle increment calculation portion 121 calculates the angle increment Δθ of the inertial measurement unit 1 in the period Δt based on the posture increment quaternion Δq calculated by the posture increment calculation portion 102.

The interface portion 122, for each period Δt, transmits the angle increment Δθ calculated by the angle increment calculation portion 121 and the velocity increment Δv calculated by the velocity increment calculation portion 112 to the host device 2 that is an external device.

The three-axis angular velocity sensor 26, the three-axis acceleration sensor 27, the minute posture change calculation portion 101, the posture increment calculation portion 102, the minute velocity change calculation portion 111, and the velocity increment calculation portion 112 periodically perform processing with the sampling period δt as one cycle. Meanwhile, the angle increment calculation portion 121 and the interface portion 122 periodically perform processing with the output period Δt as one cycle. The sampling period δt is an example of a “first period”, and the output period Δt is an example of a “second period”.

Hereinafter, detailed processing of the processing circuit 28 will be described. First, as in Equation (1), each measurement value of the angular velocity sensors 26x, 26y, and 26z is considered to be an average value of each of the angular velocities ωₓ, ω_{y}, and ω_{z} in an XYZ coordinate system applied in the sampling period δt.

$$\overline{ω} = [ \begin{matrix}{\overline{ω}}_{x} \\ {\overline{ω}}_{y} \\ {\overline{ω}}_{z}\end{matrix} ] \qquad ( 1 )$$

The three-axis angular velocity ωₖ measured at time tₖ is an average value of a three-axis angular velocity ω(t) applied in the k-th sampling period δt from time tₖ₋₁ to time tₖ, and is represented as in Equation (2) using the three-axis angular velocity ω(tₖ) at time tₖ. Here, tₖ=kδₜ is established.

$$\begin{matrix}{\overline{ω}}_{k} = \frac{1}{δ t} {\int }_{{t}_{k - 1}}^{{t}_{k}} ω ( t ) dt \\ = ω ( {t}_{k} ) - \frac{{ω}^{′} ( {t}_{k} )}{2} δ t + \frac{{ω}^{′′} ( {t}_{k} )}{6} δ {t}^{2} - \\ \frac{{ω}^{′′′} ( {t}_{k} )}{24} δ {t}^{3} + \frac{{ω}^{′′′′} ( {t}_{k} )}{120} δ {t}^{4} - ⋯\end{matrix} \qquad ( 2 )$$

The three-axis angular velocity ωₖ₊₁ measured at time tₖ₊₁ is an average value of the three-axis angular velocity ω(t) applied in the (k+1)-th sampling period δt from time tₖ to time tₖ₊₁, and is represented as in Equation (3) using the three-axis angular velocity ω(tₖ) at time tₖ.

$$\begin{matrix}{\overline{ω}}_{k + 1} = \frac{1}{δ t} {\int }_{{t}_{k}}^{{t}_{k + 1}} ω ( t ) dt \\ = ω ( {t}_{k} ) + \frac{{ω}^{′} ( {t}_{k} )}{2} δ t + \frac{{ω}^{′′} ( {t}_{k} )}{6} δ {t}^{2} + \\ \frac{{ω}^{′′′} ( {t}_{k} )}{24} δ {t}^{3} + \frac{{ω}^{′′′′} ( {t}_{k} )}{120} δ {t}^{4} + ⋯\end{matrix} \qquad ( 3 )$$

Meanwhile, the posture quaternion q representing the posture of the inertial measurement unit 1 is defined as in Equation (4). In Equation (4), i, j, and k are imaginary units.

$$q = [ \begin{matrix}{q}_{w} \\ {q}_{x} \\ {q}_{y} \\ {q}_{z}\end{matrix} ] = {q}_{w} + {q}_{x} i + {q}_{y} j + {q}_{z} k \qquad ( 4 )$$

The posture quaternion q (tₖ₊₁) at time tₖ₊₁ is obtained as a quaternion product of the posture quaternion q(tₖ) at time tₖ and the posture change quaternion δqₖ₊₁ representing the posture change of the inertial measurement unit 1 in the sampling period δt from time tₖ to time tₖ₊₁, as in Equation (5).

$$q ( {t}_{k + 1} ) = q ( {t}_{k} ) ⊗ δ {q}_{k + 1} \qquad ( 5 )$$

By multiplying both sides of Equation (5) by a conjugate quaternion q*(tₖ) of the posture quaternion q(tₖ), the posture change quaternion δqₖ₊₁ is represented by Equation (6).

$$δ {q}_{k + 1} = {q}^{*} ( {t}_{k} ) ⊗ q ( {t}_{k + 1} ) = 1 + \frac{ω ( {t}_{k} )}{2} δ t + \frac{1}{2} \{ \frac{ω ( {t}_{k} ) ⊗ ω ( {t}_{k} )}{4} + \frac{{ω}^{′} ( {t}_{k} )}{2} \} δ {t}^{2} + \frac{1}{6} \{ \frac{ω ( {t}_{k} ) ⊗ ω ( {t}_{k} ) ⊗ ω ( {t}_{k} )}{8} + \frac{ω ( {t}_{k} ) ⊗ {ω}^{′} ( {t}_{k} )}{2} + \frac{{ω}^{′} ( {t}_{k} ) ⊗ ω ( {t}_{k} )}{4} + \frac{{ω}^{′′} ( {t}_{k} )}{2} \} δ {t}^{3} + \frac{1}{24} \{ \frac{ω ( {t}_{k} ) ⊗ ω ( {t}_{k} ) ⊗ ω ( {t}_{k} ) ⊗ ω ( {t}_{k} )}{16} + \frac{3 ω ( {t}_{k} ) ⊗ ω ( {t}_{k} ) ⊗ {ω}^{′} ( {t}_{k} )}{8} + \frac{ω ( {t}_{k} ) ⊗ {ω}^{′} ( {t}_{k} ) ⊗ ω ( {t}_{k} )}{4} + \frac{3 ω ( {t}_{k} ) ⊗ {ω}^{′′} ( {t}_{k} )}{4} + \frac{{ω}^{′} ( {t}_{k} ) ⊗ ω ( {t}_{k} ) ⊗ ω ( {t}_{k} )}{8} + \frac{3 {ω}^{′} ( {t}_{k} ) ⊗ {ω}^{′} ( {t}_{k} )}{4} + \frac{{ω}^{′′} ( {t}_{k} ) ⊗ ω ( {t}_{k} )}{4} + \frac{{ω}^{′′′} ( {t}_{k} )}{2} \} δ {t}^{4} + ⋯ \qquad ( 6 )$$

When Equation (6) is rearranged using Equations (2) and (3), and terms after δt⁴ are ignored, the posture change quaternion δqₖ₊₁ is approximated by an approximation equation of Equation (7) using the three-axis angular velocity ωₖ₊₁ measured at time tₖ₊₁ and the three-axis angular velocity ωₖ measured at time tₖ. The minute posture change calculation portion 101 calculates the posture change quaternion δq using Equation (7). That is, the minute posture change calculation portion 101 calculates the posture change quaternion δq using an approximation equation that uses the three-axis angular velocity ω measured by the three-axis angular velocity sensor 26.

$$δ {q}_{k + 1} \approx 1 + \frac{{\overline{ω}}_{k + 1}}{2} δ t - \frac{{\vert {\overline{ω}}_{k + 1} \vert}^{2}}{8} δ {t}^{2} + \frac{{\overline{ω}}_{k} \times {\overline{ω}}_{k + 1}}{24} δ {t}^{2} - \frac{{\vert {\overline{ω}}_{k} \vert}^{2} {\overline{ω}}_{k + 1}}{48} δ {t}^{3} \qquad ( 7 )$$

When the output period Δt is m times longer than the sampling period δt, the posture increment quaternion Δqₖ in the k-th output period Δt is obtained as a quaternion product of m posture change quaternions δqₘ₍ₖ₋₁₎₊₁ to δqₘₖ in the output period Δt, as in Equation (8). The posture increment calculation portion 102 calculates the posture increment quaternion Δqₖ using Equation (8).

$$Δ {q}_{k} = δ {q}_{m ( k - 1 ) + 1} ⊗ δ {q}_{m ( k - 1 ) + 2} ⊗ δ {q}_{m ( k - 1 ) + 3} ⋯ ⊗ δ {q}_{mk} \qquad ( 8 )$$

The angle increment Δθₖ in the output period Δt from time τₖ₋₁ to time τₖ is a rotation vector representing the posture at time τₖ with reference to the XYZ coordinate system at time τₖ₋₁. A relationship between the angle increment Δθₖ, the posture quaternion q(τₖ₋₁) at time τₖ₋₁, and the posture quaternion q(τₖ) at time τₖ is represented by Equation (9).

$$q ( {τ}_{k} ) = q ( {τ}_{k - 1} ) ⊗ {e}^{\frac{Δ {θ}_{k}}{2}} \qquad ( 9 )$$

By modifying Equation (9), the angle increment Δθₖ in Δt is represented by Equation (10). The angle increment calculation portion 121 calculates the angle increment Δθ using Equation (10).

$$\begin{matrix}{Δθ}_{k} = 2 log \{ {q}^{*} ( {τ}_{k - 1} ) ⊗ q ( {τ}_{k} ) \} \\ = 2 log Δ {q}_{k} \\ = ( \frac{2}{\sqrt{Δ {q}_{x , k}^{2} + Δ {q}_{y , k}^{2} + Δ {q}_{z , k}^{2}}} arc tan \frac{\sqrt{Δ {q}_{x , k}^{2} + Δ {q}_{y , k}^{2} + Δ {q}_{z , k}^{2}}}{Δ {q}_{w , k}} ) \\ [ \begin{matrix}Δ {q}_{x , k} \\ Δ {q}_{y , k} \\ Δ {q}_{z , k}\end{matrix} ]\end{matrix} \qquad ( 10 )$$

As in Equation (11), the measurement value of the three-axis acceleration sensor 27, like the measurement value of the three-axis angular velocity sensor 26, is considered to be an average value of each of the accelerations αₓ, α_{y}, and α_{z} in the XYZ coordinate system applied in the sampling period δt.

$$\overline{α} = [ \begin{matrix}{\overline{α}}_{x} \\ {\overline{α}}_{y} \\ {\overline{α}}_{z}\end{matrix} ] \qquad ( 11 )$$

The three-axis acceleration ok measured at time tₖ is an average value of the three-axis acceleration α(t) applied in the k-th sampling period δt from time tₖ₋₁ to time tₖ, and is represented as in Equation (12) using the three-axis acceleration α(tₖ) at time tₖ. Here, tₖ=kδₜ is established.

$$\begin{matrix}{\overline{α}}_{k} = \frac{1}{δ t} {\int }_{{t}_{k - 1}}^{{t}_{k}} α ( t ) dt \\ = α ( {t}_{k} ) - \frac{{α}^{′} ( {t}_{k} )}{2} δ t + \frac{{α}^{′′} ( {t}_{k} )}{6} δ {t}^{2} - \\ \frac{{α}^{′′′} ( {t}_{k} )}{24} δ {t}^{3} + \frac{{α}^{′′′′} ( {t}_{k} )}{120} δ {t}^{4} - ⋯\end{matrix} \qquad ( 12 )$$

The three-axis acceleration αₖ₊₁ measured at time tₖ₊₁ is an average value of the three-axis acceleration α(t) applied in the (k+1)-th sampling period δt from time tₖ to time tₖ₊₁, and is represented as in Equation (13) using the three-axis acceleration α(tₖ) at time tₖ.

$$\begin{matrix}{\overline{α}}_{k + 1} = \frac{1}{δ t} {\int }_{{t}_{k}}^{{t}_{k + 1}} α ( t ) dt \\ = α ( {t}_{k} ) + \frac{{α}^{′} ( {t}_{k} )}{2} δ t + \frac{{α}^{′′} ( {t}_{k} )}{6} δ {t}^{2} + \\ \frac{{α}^{′′′} ( {t}_{k} )}{24} δ {t}^{3} + \frac{{α}^{′′′′} ( {t}_{k} )}{120} δ {t}^{4} + ⋯\end{matrix} \qquad ( 13 )$$

The velocity change δvₖ₊₁ of the inertial measurement unit 1 in the sampling period δt from time tₖ to time tₖ₊₁ is represented by Equation (14) using the posture quaternion q(tₖ) at time tₖ.

$$δ {v}_{k + 1} = {q}^{*} ( {t}_{k} ) ⊗ \{ v ( {t}_{k + 1} ) - v ( {t}_{k} ) \} ⊗ q ( {t}_{k} ) = α ( {t}_{k} ) δ t + \frac{1}{2} \{ \frac{ω ( {t}_{k} ) ⊗ α ( {t}_{k} )}{2} - \frac{α ( {t}_{k} ) ⊗ ω ( {t}_{k} )}{2} + {α}^{′} ( {t}_{k} ) \} δ {t}^{2} + \frac{1}{6} \{ \frac{ω ( {t}_{k} ) ⊗ ω ( {t}_{k} ) ⊗ α ( {t}_{k} )}{4} - \frac{ω ( {t}_{k} ) ⊗ α ( {t}_{k} ) ⊗ ω ( {t}_{k} )}{2} + \frac{α ( {t}_{k} ) ⊗ ω ( {t}_{k} ) ⊗ ω ( {t}_{k} )}{4} + ω ( {t}_{k} ) ⊗ {α}^{′} ( {t}_{k} ) - {α}^{′} ( {t}_{k} ) ⊗ ω ( {t}_{k} ) + \frac{{ω}^{′} ( {t}_{k} ) ⊗ α ( {t}_{k} )}{2} - \frac{α ( {t}_{k} ) ⊗ {ω}^{′} ( {t}_{k} )}{2} + {α}^{′′} ( {t}_{k} ) \} δ {t}^{3} + \frac{1}{24} \{ \frac{ω ( {t}_{k} ) ⊗ ω ( {t}_{k} ) ⊗ ω ( {t}_{k} ) ⊗ α ( {t}_{k} )}{8} - \frac{3 ω ( {t}_{k} ) ⊗ ω ( {t}_{k} ) ⊗ α ( {t}_{k} ) ⊗ ω ( {t}_{k} )}{8} + \frac{3 ω ( {t}_{k} ) ⊗ α ( {t}_{k} ) ⊗ ω ( {t}_{k} ) ⊗ ω ( {t}_{k} )}{8} - \frac{α ( {t}_{k} ) ⊗ ω ( {t}_{k} ) ⊗ ω ( {t}_{k} ) ⊗ ω ( {t}_{k} )}{8} + \frac{3 ω ( {t}_{k} ) ⊗ ω ( {t}_{k} ) ⊗ {α}^{′} ( {t}_{k} )}{4} - \frac{3 ω ( {t}_{k} ) ⊗ {α}^{′} ( {t}_{k} ) ⊗ ω ( {t}_{k} )}{2} + \frac{3 {α}^{′} ( {t}_{k} ) ⊗ ω ( {t}_{k} ) ⊗ ω ( {t}_{k} )}{4} - \frac{3 ω ( {t}_{k} ) ⊗ α ( {t}_{k} ) ⊗ {ω}^{′} ( {t}_{k} )}{4} + \frac{ω ( {t}_{k} ) ⊗ {ω}^{′} ( {t}_{k} ) ⊗ α ( {t}_{k} )}{2} + \frac{{ω}^{′} ( {t}_{k} ) ⊗ ω ( {t}_{k} ) ⊗ α ( {t}_{k} )}{4} - \frac{3 {ω}^{′} ( {t}_{k} ) ⊗ α ( {t}_{k} ) ⊗ ω ( {t}_{k} )}{4} + \frac{α ( {t}_{k} ) ⊗ {ω}^{′} ( {t}_{k} ) ⊗ ω ( {t}_{k} )}{2} + \frac{α ( {t}_{k} ) ⊗ ω ( {t}_{k} ) ⊗ {ω}^{′} ( {t}_{k} )}{4} + \frac{3 ω ( {t}_{k} ) ⊗ {α}^{′′} ( {t}_{k} )}{2} - \frac{3 {α}^{′′} ( {t}_{k} ) ⊗ ω ( {t}_{k} )}{2} + \frac{3 {ω}^{′} ( {t}_{k} ) ⊗ {α}^{′} ( {t}_{k} )}{2} - \frac{3 {α}^{′} ( {t}_{k} ) ⊗ {ω}^{′} ( {t}_{k} )}{2} + \frac{{ω}^{′′} ( {t}_{k} ) ⊗ α ( {t}_{k} )}{2} - \frac{α ( {t}_{k} ) ⊗ {ω}^{′′′} ( {t}_{k} )}{2} + {α}^{′′′} ( {t}_{k} ) \} δ {t}^{4} + ⋯ \qquad ( 14 )$$

When Equation (14) is rearranged using Equations (12) and (13), and terms after δt⁴ are ignored, the velocity change δvₖ₊₁ is approximated by an approximation equation of Equation (15) using the three-axis acceleration αₖ₊₁ measured at time tₖ₊₁ and the three-axis acceleration αₖ measured at time tₖ. The minute velocity change calculation portion 111 calculates the velocity change δv using Equation (15). That is, the minute velocity change calculation portion 111 calculates the velocity change δv using an approximation equation that uses the three-axis angular velocity ω measured by the three-axis angular velocity sensor 26 and the three-axis acceleration α measured by the three-axis acceleration sensor 27.

$$δ {v}_{k + 1} \approx {\overline{α}}_{k} δ t + \frac{{\overline{ω}}_{k} \times {\overline{α}}_{k}}{2} δ {t}^{2} + \frac{{\overline{ω}}_{k - 1} \times {\overline{α}}_{k}}{12} δ {t}^{2} - \frac{{\overline{ω}}_{k} \times {\overline{α}}_{k - 1}}{12} δ {t}^{2} + \frac{{\overline{ω}}_{k} \times ( {\overline{ω}}_{k} \times {\overline{α}}_{k} )}{6} δ {t}^{3} \qquad ( 15 )$$

When the output period Δt is m times longer than the sampling period δt, the velocity increment Δvₖ in the k-th output period Δt is obtained by accumulating m velocity changes δvₘ₍ₖ₋₁₎₊₁ to δvₘₖ in the output period Δt while performing coordinate transformation in accordance with the posture quaternion q, as in Equations (16) and (17). The velocity increment calculation portion 112 calculates the velocity increment Δvₖ using Equations (16) and (17).

$$Δ {v}_{k} = {\sum }_{n = 1}^{m} {C}_{k , n - 1} δ {v}_{m ( k - 1 ) + n} \qquad ( 16 )$$

$${C}_{k , j} = [ \begin{matrix}{q}_{w , k , j}^{2} + {q}_{x , k , j}^{2} - {q}_{y , k , j}^{2} - {q}_{z , k , j}^{2} & 2 ( {q}_{x , k , j} {q}_{y , k , j} - {q}_{w , k , j} {q}_{z , k , j} ) & 2 ( {q}_{x , k , j} {q}_{z , k , j} + {q}_{w , k , j} {q}_{y , k , j} ) \\ 2 ( {q}_{x , k , j} {q}_{y , k , j} + {q}_{w , k , j} {q}_{z , k , j} ) & {q}_{w , k , j}^{2} - {q}_{x , k , j}^{2} + {q}_{y , k , j}^{2} - {q}_{z , k , j}^{2} & 2 ( {q}_{y , k , j} {q}_{x , k , j} - {q}_{w , k , j} {q}_{x , k , j} ) \\ 2 ( {q}_{x , k , j} {q}_{z , k , j} - {q}_{w , k , j} {q}_{y , k , j} ) & 2 ( {q}_{y , k , j} {q}_{z , k , j} + {q}_{w , k , j} {q}_{x , k , j} ) & {q}_{w , k , j}^{2} - {q}_{x , k , j}^{2} - {q}_{y , k , j}^{2} + {q}_{z , k , j}\end{matrix} ] \qquad ( 17 )$$

### 1-3. Procedure for Calculating Angle Increment Δθ and Velocity Increment Δv

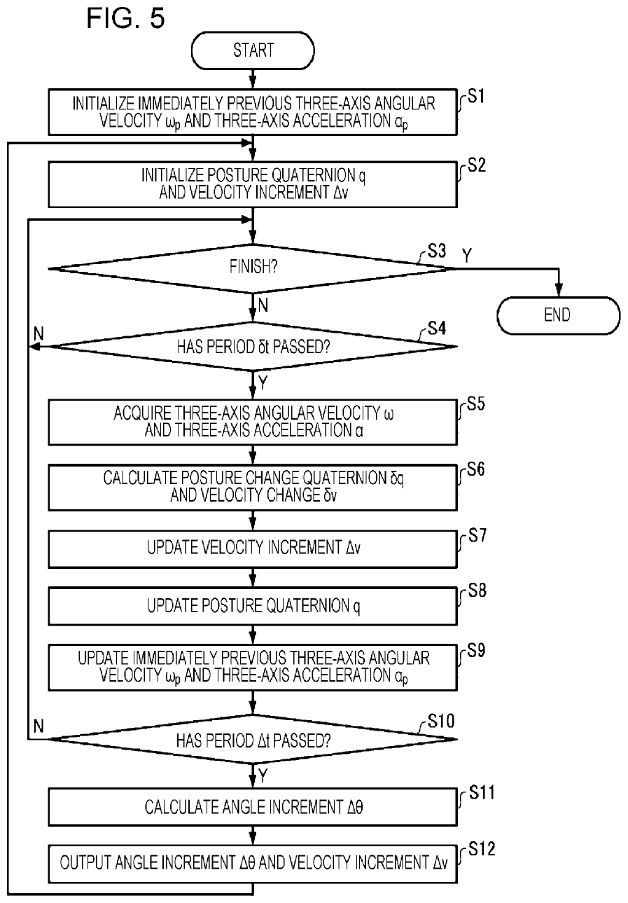

FIG. 5 is a flowchart showing an example of a procedure for calculating the angle increment Δθ and the velocity increment Δv via the processing circuit 28.

As shown in FIG. 5, first, in step S1, the processing circuit 28 initializes the three-axis angular velocity ωₚ and the three-axis acceleration αₚ that are immediately previous measurement values, as shown in Equations (18) and (19).

$${\overline{ω}}_{p} = [ \begin{matrix}{\overline{ω}}_{px} \\ {\overline{ω}}_{py} \\ {\overline{ω}}_{pz}\end{matrix} ] ← [ \begin{matrix}0 \\ 0 \\ 0\end{matrix} ] \qquad ( 18 )$$

$${\overline{α}}_{p} = [ \begin{matrix}{\overline{α}}_{px} \\ {\overline{α}}_{py} \\ {\overline{α}}_{pz}\end{matrix} ] ← [ \begin{matrix}0 \\ 0 \\ 0\end{matrix} ] \qquad ( 19 )$$

Next, in step S2, the processing circuit 28 initializes the posture quaternion q and the velocity increment Δv as shown in Equations (20) and (21).

$$q = [ \begin{matrix}{q}_{w} \\ {q}_{x} \\ {q}_{y} \\ {q}_{z}\end{matrix} ] ← [ \begin{matrix}1 \\ 0 \\ 0 \\ 0\end{matrix} ] \qquad ( 20 )$$

$$Δ v = [ \begin{matrix}Δ {v}_{x} \\ Δ {v}_{y} \\ Δ {v}_{z}\end{matrix} ] ← [ \begin{matrix}0 \\ 0 \\ 0\end{matrix} ] \qquad ( 21 )$$

Next, when the sampling period δt passes in step S4 without finishing processing in step S3, the processing circuit 28, in step S5, acquires the three-axis angular velocity ω and the three-axis acceleration α from the three-axis angular velocity sensor 26 and the three-axis acceleration sensor 27 as shown in Equations (22) and (23).

$$\overline{ω} = [ \begin{matrix}{\overline{ω}}_{x} \\ {\overline{ω}}_{y} \\ {\overline{ω}}_{z}\end{matrix} ] \qquad ( 22 )$$

$$\overline{α} = [ \begin{matrix}{\overline{α}}_{x} \\ {\overline{α}}_{y} \\ {\overline{α}}_{z}\end{matrix} ] \qquad ( 23 )$$

Next, in step S6, the processing circuit 28 calculates the posture change quaternion δq and the velocity change δv as shown in Equations (24) and (25). Equation (24) corresponds to Equation (7) described above, and Equation (25) corresponds to Equation (15) described above.

$$δ q = [ \begin{matrix}δ {q}_{w} \\ δ {q}_{x} \\ δ {q}_{y} \\ δ {q}_{z}\end{matrix} ] = [ \begin{matrix}δ {q}_{w} \\ [ \begin{matrix}δ {q}_{x} \\ δ {q}_{y} \\ δ {q}_{z}\end{matrix} ]\end{matrix} ] ← [ \begin{matrix}1 - \frac{{\vert \overline{ω} \vert}^{2}}{8} δ {t}^{2} \\ \frac{\overline{ω}}{2} δ t + \frac{{\overline{ω}}_{p} \times \overline{ω}}{24} δ {t}^{2} - \frac{{\vert \overline{ω} \vert}^{2} \overline{ω}}{48} δ {t}^{3}\end{matrix} ] \qquad ( 24 )$$

$$δ v = [ \begin{matrix}δ {v}_{x} \\ δ {v}_{y} \\ δ {v}_{z}\end{matrix} ] ← \overline{α} δ t + \frac{\overline{ω} \times \overline{α}}{2} δ {t}^{2} + \frac{{\overline{ω}}_{p} \times \overline{α}}{12} δ {t}^{2} - \frac{\overline{ω} \times {\overline{α}}_{p}}{12} δ {t}^{2} + \frac{\overline{ω} \times ( \overline{ω} \times \overline{α} )}{6} δ {t}^{3} \qquad ( 25 )$$

Next, in step S7, the processing circuit 28 updates the velocity increment Δv as shown in Equation (26).

$$Δ v ← Δ v + [ \begin{matrix}{q}_{w}^{2} + {q}_{x}^{2} - {q}_{y}^{2} - {q}_{z}^{2} & 2 ( {q}_{x} {q}_{y} - {q}_{w} {q}_{z} ) & 2 ( {q}_{x} {q}_{z} + {q}_{w} {q}_{y} ) \\ 2 ( {q}_{x} {q}_{y} + {q}_{w} {q}_{z} ) & {q}_{w}^{2} - {q}_{x}^{2} + {q}_{y}^{2} - {q}_{z}^{2} & 2 ( {q}_{y} {q}_{z} - {q}_{w} {q}_{x} ) \\ 2 ( {q}_{x} {q}_{z} - {q}_{w} {q}_{y} ) & 2 ( {q}_{y} {q}_{z} + {q}_{w} {q}_{x} ) & {q}_{w}^{2} - {q}_{x}^{2} - {q}_{y}^{2} + {q}_{z}^{2}\end{matrix} ] δ v \qquad ( 26 )$$

Next, in step S8, the processing circuit 28 updates the posture quaternion q as shown in Equation (27).

$$q ← q ⊗ δ q = [ \begin{matrix}{q}_{w} δ {q}_{w} - {q}_{x} δ {q}_{x} - {q}_{y} δ {q}_{y} - {q}_{z} δ {q}_{z} \\ {q}_{x} δ {q}_{w} + {q}_{w} δ {q}_{x} - {q}_{z} δ {q}_{y} + {q}_{y} δ {q}_{z} \\ {q}_{y} δ {q}_{w} + {q}_{w} δ {q}_{x} + {q}_{w} δ {q}_{y} - {q}_{xy} δ {q}_{z} \\ {q}_{z} δ {q}_{w} - {q}_{y} δ {q}_{x} + {q}_{x} δ {q}_{y} + {q}_{w} δ {q}_{z}\end{matrix} ] \qquad ( 27 )$$

Next, in step S9, the processing circuit 28 updates the three-axis angular velocity ωₚ and the three-axis acceleration αₚ which are the immediately previous measurement values, as shown in Equations (28) and (29).

$${\overline{ω}}_{p} ← \overline{ω} \qquad ( 28 )$$

$${\overline{α}}_{p} ← \overline{α} \qquad ( 29 )$$

Next, in step S10, when the output period Δt has not passed, the processing circuit 28 performs the processing of steps S3 to S9 again.

In step S10, when the output period Δt has passed, the processing circuit 28, in step S11, calculates the angle increment Δθ with Equation (30) using the most recent posture quaternion q updated in step S8. Equation (30) corresponds to Equation (10) described above. The most recent posture quaternion q corresponds to the posture increment quaternion Δq.

$$Δθ = [ \begin{matrix}{Δθ}_{x} \\ {Δθ}_{y} \\ {Δθ}_{z}\end{matrix} ] = ( \frac{2}{\sqrt{{q}_{x}^{2} + {q}_{y}^{2} + {q}_{z}^{2}}} arctan \frac{\sqrt{{q}_{x}^{2} + {q}_{y}^{2} + {q}_{z}^{2}}}{{q}_{w}} ) [ \begin{matrix}{q}_{x} \\ {q}_{y} \\ {q}_{z}\end{matrix} ] \qquad ( 30 )$$

Next, in step S12, the processing circuit 28 outputs the angle increment Δθ calculated in step S11 and the most recent velocity increment Δv updated in step S7 to the host device 2. The processing circuit 28 repeats the processing from step S2 until the processing is finished in step S3.

### 1-4. Verification of Effect by Simulation

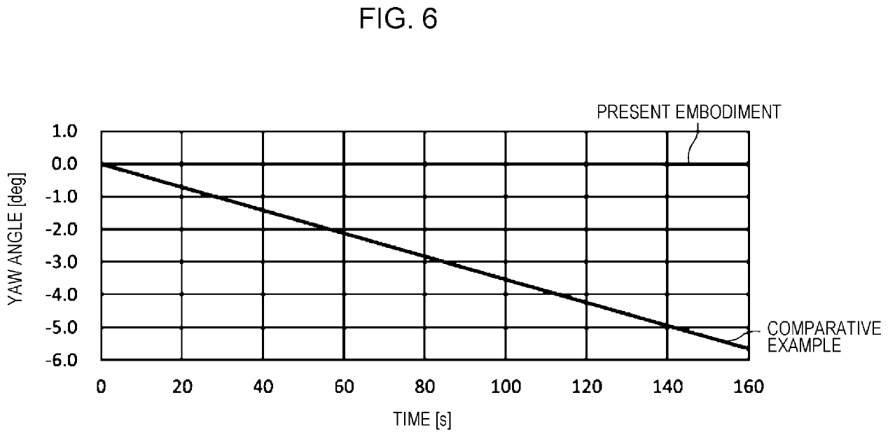

The present inventors have verified an effect of reducing a drift in a posture angle by simulating a case where the inertial measurement unit 1 moves in a coning motion. The coning motion is, for example, a motion in which the Z axis draws a cone. In navigation calculation, the coning motion is known to cause a drift in the yaw angle that is the posture angle. First, the coning motion is represented by a predetermined model equation, and under a predetermined simulation condition, the three-axis angular velocity ω measured by the three-axis angular velocity sensor 26 and the three-axis acceleration α measured by the three-axis acceleration sensor 27 are obtained by calculation from the model equation. The angle increment Δθ and the velocity increment Δv for each output period Δt=mδt are calculated based on the calculated three-axis angular velocity ω and the calculated three-axis acceleration α, and the posture angle and the velocity are estimated by navigation calculation using the calculated angle increment Δθ and the calculated velocity increment Δv. In addition, as a comparative example, the posture angle and the velocity are estimated by navigation calculation using the angle increment and the velocity increment obtained by simply accumulating each of the calculated three-axis angular velocity ω and the calculated three-axis acceleration α. FIG. 6 is a simulation result of a drift in the yaw angle which is the posture angle. As is understood from FIG. 6, in the method of the comparative example, the yaw angle drifts as time passes. Meanwhile, in the method of the present embodiment, a drift in the yaw angle is significantly reduced.

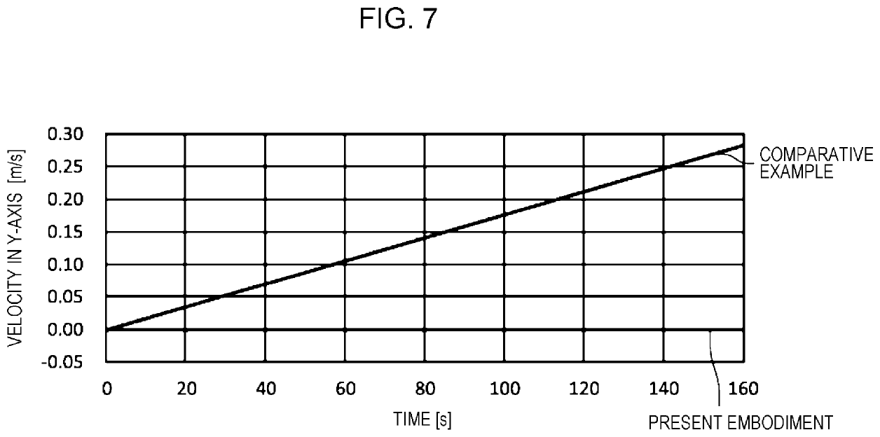

Furthermore, the present inventors have verified an effect of reducing a drift in the velocity by simulating a case where the inertial measurement unit 1 moves in a sculling motion. The sculling motion is a motion of rowing a boat, and is, for example, a motion of rotating about the Z axis while reciprocating in the X-axis direction. The sculling motion is known to cause a drift in the velocity in the Y-axis direction. First, the sculling motion is represented by a predetermined model equation, and under a predetermined simulation condition, the three-axis angular velocity ω measured by the three-axis angular velocity sensor 26 and the three-axis acceleration α measured by the three-axis acceleration sensor 27 are obtained by calculation from the model equation. The angle increment Δθ and the velocity increment Δv for each output period Δt=mδt are calculated based on the calculated three-axis angular velocity ω and the calculated three-axis acceleration α, and the posture angle and the velocity are estimated by navigation calculation using the calculated angle increment Δθ and the calculated velocity increment Δv. In addition, as a comparative example, the posture angle and the velocity are estimated by navigation calculation using the angle increment and the velocity increment obtained by simply accumulating each of the calculated three-axis angular velocity ω and the calculated three-axis acceleration α. FIG. 7 is a simulation result of a drift in the velocity in the Y-axis direction. As is understood from FIG. 7, in the method of the comparative example, the velocity in the Y-axis direction drifts as time passes. Meanwhile, in the method of the present embodiment, a drift in the velocity in the Y-axis direction is significantly reduced.

### 1-5. Operations and Effects

In the inertial measurement unit 1 of the first embodiment described above, the processing circuit 28 calculates the posture increment quaternion Δq in the output period Δt by combining the posture change quaternions δq representing the posture change of the inertial measurement unit 1 for each sampling period δt, and calculates the angle increment Δθ in the output period Δt based on the posture increment quaternion Δq. That is, according to the inertial measurement unit 1 of the first embodiment, since the processing circuit 28 can calculate the angle increment Δθ with high accuracy with reference to the posture of the inertial measurement unit 1 for each sampling period δt, a drift in the three-dimensional posture of the inertial measurement unit 1 obtained by integrating the angle increment Δθ with respect to time via the host device 2 is significantly reduced. Therefore, according to the inertial measurement unit 1 of the first embodiment, since processing for correcting a drift in the three-dimensional angle via the host device 2 is reduced, a calculation load of the host device 2 can be reduced.

In addition, in the inertial measurement unit 1 of the first embodiment, since the processing circuit 28 calculates a continuous change in the posture of the inertial measurement unit 1 in a discrete manner using Approximation Equation (7) which uses the measured three-axis angular velocity ω, a calculation load of the processing circuit 28 can be reduced while reducing error in the angle increment Δθ.

Furthermore, in the inertial measurement unit 1 of the first embodiment, since the processing circuit 28 can calculate the velocity increment Δv with high accuracy with reference to the posture of the inertial measurement unit 1 for each sampling period δt, a drift in the three-dimensional position of the inertial measurement unit 1 obtained by integrating the velocity increment Δv with respect to time via the host device 2 is significantly reduced. Therefore, according to the inertial measurement unit 1 of the first embodiment, since processing for correcting a drift in the three-dimensional position via the host device 2 is reduced, the calculation load of the host device 2 can be reduced.

In addition, in the inertial measurement unit 1 of the first embodiment, since the processing circuit 28 calculates a continuous change in the velocity of the inertial measurement unit 1 in a discrete manner using Approximation Equation (15) which uses the measured three-axis angular velocity ω and the measured three-axis acceleration α, the calculation load of the processing circuit 28 can be reduced while reducing error in the velocity increment Δv.

### 2. Second Embodiment

Hereinafter, an inertial measurement unit of the second embodiment will be described with a focus on contents different from the first embodiment. The same constituents as those in the first embodiment will be designated by the same reference symbols, and descriptions provided in the first embodiment will not be repeated or will be simplified.

While the inertial measurement unit 1 of the first embodiment includes the three-axis acceleration sensor 27 and calculates the velocity increment Δv, the inertial measurement unit 1 of the second embodiment does not include the three-axis acceleration sensor 27 and does not calculate the velocity increment Δv.

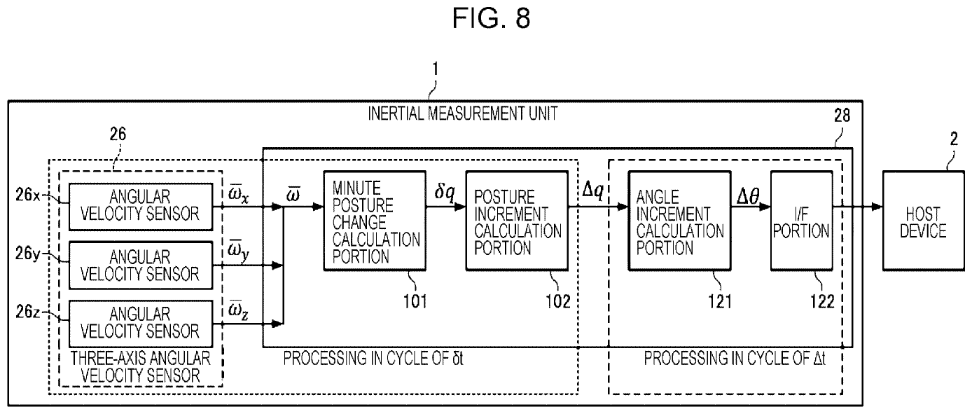

FIG. 8 is a diagram showing an example of a functional configuration of the inertial measurement unit 1 of the second embodiment. As shown in FIG. 8, the inertial measurement unit 1 includes the three-axis angular velocity sensor 26 consisting of the angular velocity sensors 26x, 26y, and 26z, and the processing circuit 28, and is coupled to the host device 2.

The three-axis angular velocity sensor 26 measures the three-axis angular velocity ω=(ωₓ, ω_{y}, ω_{z}) for each sampling period δt.

The three-axis angular velocity ω=(ωₓ, ω_{y}, ω_{z}) measured by the three-axis angular velocity sensor 26 is input into the processing circuit 28. The processing circuit 28 calculates the angle increment Δθ for each output period Δt longer than the sampling period δt based on the three-axis angular velocity ω=(ωₓ, ω_{y}, ω_{z}), and transmits the angle increment Δθ to the host device 2.

The processing circuit 28 actually performs various types of correction processing such as misalignment correction and correction of an offset error and a scale factor error in addition to the processing of calculating the angle increment Δθ. However, FIG. 8 shows only a circuit block for calculating the angle increment Δθ and does not show a circuit block for performing the various types of correction processing.

As shown in FIG. 8, the processing circuit 28 includes the minute posture change calculation portion 101, the posture increment calculation portion 102, the angle increment calculation portion 121, and the interface portion 122. Functions of the minute posture change calculation portion 101, the posture increment calculation portion 102, and the angle increment calculation portion 121 are the same as those in the first embodiment. Thus, descriptions of the functions will not be repeated.

The interface portion 122, for each period Δt, transmits the angle increment Δθ calculated by the angle increment calculation portion 121 to the host device 2 which is the external device.

The three-axis angular velocity sensor 26, the minute posture change calculation portion 101, and the posture increment calculation portion 102 periodically perform processing with the sampling period δt as one cycle. Meanwhile, the angle increment calculation portion 121 and the interface portion 122 periodically perform processing with the output period Δt as one cycle.

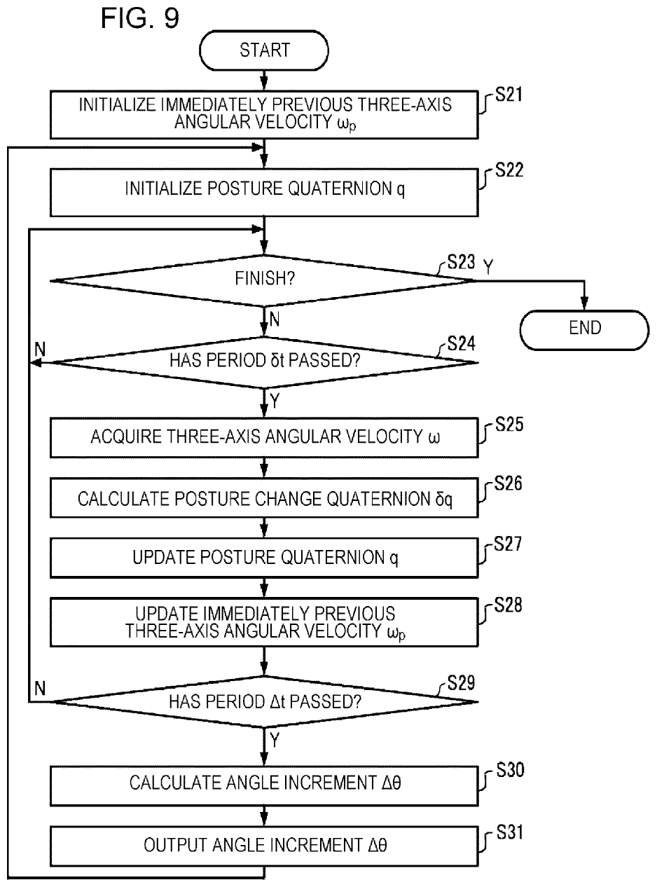

FIG. 9 is a flowchart showing an example of a procedure for calculating the angle increment Δθ via the processing circuit 28.

As shown in FIG. 9, first, in step S21, the processing circuit 28 initializes the three-axis angular velocity ωₚ which is the immediately previous measurement value, as shown in Equation (18) described above.

Next, in step S22, the processing circuit 28 initializes the posture quaternion q as shown in Equation (20) described above.

Next, when the sampling period δt passes in step S24 without finishing processing in step S23, the processing circuit 28, in step S25, acquires the three-axis angular velocity ω from the three-axis angular velocity sensor 26 as shown in Equation (22) described above.

Next, in step S26, the processing circuit 28 calculates the posture change quaternion δq as shown in Equation (24) described above.

Next, in step S27, the processing circuit 28 updates the posture quaternion q as shown in Equation (27) described above.

Next, in step S28, the processing circuit 28 updates the three-axis angular velocity ωₚ which is the immediately previous measurement value, as shown in Equation (28) described above.

Next, in step S29, when the output period Δt has not passed, the processing circuit 28 performs the processing of steps S23 to S28 again.

In step S29, when the output period Δt has passed, the processing circuit 28, in step S30, calculates the angle increment Δθ with Equation (30) described above, using the most recent posture quaternion q updated in step S27. The most recent posture quaternion q corresponds to the posture increment quaternion Δq.

Next, in step S31, the processing circuit 28 outputs the angle increment Δθ calculated in step S30 to the host device 2. The processing circuit 28 repeats the processing from step S22 until the processing is finished in step S23.

Other configurations and functions of the inertial measurement unit 1 of the second embodiment are the same as those in the first embodiment. Thus, descriptions of the configurations and the functions will not be repeated.

In the inertial measurement unit 1 of the second embodiment described above, the processing circuit 28 calculates the posture increment quaternion Δq in the output period Δt by combining the posture change quaternions δq representing the posture change of the inertial measurement unit 1 for each sampling period δt, and calculates the angle increment Δθ in the output period Δt based on the posture increment quaternion Δq. That is, according to the inertial measurement unit 1 of the second embodiment, since the processing circuit 28 can calculate the angle increment Δθ with high accuracy with reference to the posture of the inertial measurement unit 1 for each sampling period δt, a drift in the three-dimensional posture of the inertial measurement unit 1 obtained by integrating the angle increment Δθ with respect to time via the host device 2 is significantly reduced. Therefore, according to the inertial measurement unit 1 of the second embodiment, since processing for correcting a drift in the three-dimensional angle via the host device 2 is reduced, a calculation load of the host device 2 can be reduced.

In addition, in the inertial measurement unit 1 of the second embodiment, since the processing circuit 28 calculates a continuous change in the posture of the inertial measurement unit 1 in a discrete manner using Approximation Equation (7) which uses the measured three-axis angular velocity ω, a calculation load of the processing circuit 28 can be reduced while reducing error in the angle increment Δθ.

The present disclosure is not limited to the present embodiment, and various modifications can be made without departing from the gist of the present disclosure.

The embodiments and the modification examples described above are merely examples, and the present disclosure is not limited to these. For example, each embodiment and each modification example can be combined as appropriate.

The present disclosure includes configurations that are substantially identical to the configurations described in the embodiments, for example, configurations having identical functions, methods, and effects, or configurations having identical objects and effects. In addition, the present disclosure includes configurations obtained by replacing non-essential parts of the configurations described in the embodiments. In addition, the present disclosure includes configurations that exhibit identical operations and effects to the configurations described in the embodiments, or configurations having identical objects to the configurations described in the embodiments. In addition, the present disclosure includes configurations obtained by applying a well-known technology to the configurations described in the embodiments.

The following contents are derived from the embodiments and the modification examples described above.

According to an aspect, an inertial measurement unit includes a three-axis angular velocity sensor that measures a three-axis angular velocity along three axes orthogonal to each other for each first period, a minute posture change calculation portion that calculates a posture change quaternion representing a posture change in the first period based on the three-axis angular velocity measured by the three-axis angular velocity sensor, a posture increment calculation portion that calculates a posture quaternion by combining the posture change quaternions for each first period, and calculates a posture increment quaternion representing a posture increment in a second period longer than the first period, an angle increment calculation portion that calculates an angle increment in the second period based on the posture increment quaternion, and an interface portion that transmits the angle increment to an external device for each second period.

The inertial measurement unit calculates the posture increment quaternion in the second period by combining the posture change quaternions representing the posture change for each first period, and calculates the angle increment in the second period based on the posture increment quaternion. That is, according to the inertial measurement unit, since the angle increment can be calculated with high accuracy with reference to the posture for each first period, a drift in a three-dimensional posture obtained by integrating the angle increment with respect to time via the external device is significantly reduced. Therefore, according to the inertial measurement unit, since processing for correcting a drift in a three-dimensional angle via the external device is reduced, a calculation load of the external device can be reduced.

The inertial measurement unit of the aspect may further include a three-axis acceleration sensor that measures a three-axis acceleration along three axes orthogonal to each other for each first period, a minute velocity change calculation portion that calculates a velocity change in the first period based on the three-axis angular velocity measured by the three-axis angular velocity sensor and on the three-axis acceleration measured by the three-axis acceleration sensor, and a velocity increment calculation portion that calculates a velocity increment in the second period by accumulating the velocity changes for each first period with reference to the posture quaternion, in which the interface portion transmits the velocity increment to the external device for each second period.

According to the inertial measurement unit, since the velocity increment can be calculated with high accuracy with reference to the posture for each first period, a drift in a three-dimensional position obtained by integrating the velocity increment with respect to time via the external device is significantly reduced. Therefore, according to the inertial measurement unit, since processing for correcting a drift in the three-dimensional position via the external device is reduced, the calculation load of the external device can be reduced.

In the inertial measurement unit of the aspect, the minute posture change calculation portion may calculate the posture change quaternion using an approximation equation that uses the three-axis angular velocity measured by the three-axis angular velocity sensor.

According to the inertial measurement unit, by calculating a continuous change in the posture in a discrete manner using the approximation equation that uses the measured three-axis angular velocity, a calculation load can be reduced while reducing error in the angle increment.

In the inertial measurement unit of the aspect, the minute velocity change calculation portion may calculate the velocity change using an approximation equation that uses the three-axis angular velocity measured by the three-axis angular velocity sensor and the three-axis acceleration measured by the three-axis acceleration sensor.

According to the inertial measurement unit, by calculating a continuous change in the velocity in a discrete manner using the approximation equation that uses the measured three-axis angular velocity and the measured three-axis acceleration, a calculation load can be reduced while reducing error in the velocity increment.

What is claimed is:

1. An inertial measurement unit comprising:
a three-axis angular velocity sensor that measures a three-axis angular velocity along three axes orthogonal to each other for each first period;
a minute posture change calculation portion that calculates a posture change quaternion representing a posture change in the first period based on the three-axis angular velocity measured by the three-axis angular velocity sensor;
a posture increment calculation portion that calculates a posture quaternion by combining the posture change quaternions for each first period, and calculates a posture increment quaternion representing a posture increment in a second period longer than the first period;
an angle increment calculation portion that calculates an angle increment in the second period based on the posture increment quaternion; and
an interface portion that transmits the angle increment to an external device for each second period.

2. The inertial measurement unit according to claim 1, further comprising:
a three-axis acceleration sensor that measures a three-axis acceleration along three axes orthogonal to each other for each first period;
a minute velocity change calculation portion that calculates a velocity change in the first period based on the three-axis angular velocity measured by the three-axis angular velocity sensor and on the three-axis acceleration measured by the three-axis acceleration sensor; and
a velocity increment calculation portion that calculates a velocity increment in the second period by accumulating the velocity changes for each first period with reference to the posture quaternion, wherein
the interface portion transmits the velocity increment to the external device for each second period.

3. The inertial measurement unit according to claim 1, wherein
the minute posture change calculation portion calculates the posture change quaternion using an approximation equation that uses the three-axis angular velocity measured by the three-axis angular velocity sensor.

4. The inertial measurement unit according to claim 2, wherein
the minute velocity change calculation portion calculates the velocity change using an approximation equation that uses the three-axis angular velocity measured by the three-axis angular velocity sensor and the three-axis acceleration measured by the three-axis acceleration sensor.
